(19) United States
(12) Patent Application Publication
(10) Pub. No.: US 2023/0299835 A1
(43) Pub. Date: Sep. 21, 2023

(54) ANTENNA ISOLATION FOR FULL DUPLEX WITH DUAL ANTENNA PANELS

(71) Applicant: NOKIA TECHNOLOGIES OY, Espoo (FI)

(72) Inventors: Simon SVENDSEN, Aalborg (DK); Christian ROM, Aalborg (DK); Johannes HARREBEK, Aalborg (DK); Benny VEJLGAARD, Gistrup (DK)

(73) Assignee: NOKIA TECHNOLOGIES OY, Espoo (FI)

(21) Appl. No.: 18/004,471

(22) PCT Filed: Jun. 8, 2021
(86) PCT No.: PCT/FI2021/050425

§ 371 Date: Jan. 6, 2023

(30) Foreign Application Priority Data
Jul. 6, 2020 (FI) 20205727

(51) Int. Cl. H04B 7/06; H01Q 1/52; H01Q 21/28; H01Q 1/24; H04W 16/28

(52) U.S. Cl. CPC H04B 7/0691; H01Q 1/243; H01Q 1/521; H01Q 21/28; H04W 16/28

(57) ABSTRACT

Abstract: Disclosed is a method comprising increasing an antenna isolation between a first antenna panel and a second antenna panel by adjusting a radiation pattern associated with the first antenna panel and/or with the second antenna panel (1501). A first signal is then received via the first antenna panel and a second signal is transmitted via the second antenna panel substantially simultaneously (1502).

### FIELD

The following exemplary embodiments relate to wireless communication.

### BACKGROUND

As resources are limited, it is desirable to optimize the usage of network resources. A cell in a cellular communication network may be utilized such that better service may be provided to one or more terminal devices. The optimization of the usage of one or more cells may therefore enable better usage of resources and enhanced user experience to a user of a terminal device.

### SUMMARY

The scope of protection sought for various exemplary embodiments is set out by the independent claims. The exemplary embodiments and features, if any, described in this specification that do not fall under the scope of the independent claims are to be interpreted as examples useful for understanding various exemplary embodiments.

According to an aspect, there is provided an apparatus comprising at least one processor, and at least one memory including computer program code, wherein the at least one memory and the computer program code are configured, with the at least one processor, to cause the apparatus to: increase an antenna isolation between a first antenna panel and a second antenna panel by adjusting a radiation pattern associated with the first antenna panel and/or with the second antenna panel, and to receive a first signal via the first antenna panel and transmit a second signal via the second antenna panel substantially simultaneously.

According to another aspect, there is provided an apparatus comprising means for increasing an antenna isolation between a first antenna panel and a second antenna panel by adjusting a radiation pattern associated with the first antenna panel and/or with the second antenna panel, and receiving a first signal via the first antenna panel and transmitting a second signal via the second antenna panel substantially simultaneously.

According to another aspect, there is provided a system comprising at least a terminal device and a base station, wherein the terminal device is configured to increase an antenna isolation between a first antenna panel and a second antenna panel by adjusting a radiation pattern associated with the first antenna panel and/or with the second antenna panel, and receive a first signal from the base station via the first antenna panel and transmit a second signal to the base station via the second antenna panel substantially simultaneously; and wherein the base station is configured to transmit the first signal to the terminal device and receive the second signal from the terminal device substantially simultaneously.

According to another aspect, there is provided a system comprising at least a terminal device and a base station, wherein the terminal device comprises means for increasing an antenna isolation between a first antenna panel and a second antenna panel by adjusting a radiation pattern associated with the first antenna panel and/or with the second antenna panel, and receiving a first signal from the base station via the first antenna panel and transmitting a second signal to the base station via the second antenna panel substantially simultaneously; and wherein the base station comprises means for transmitting the first signal to the terminal device and receiving the second signal from the terminal device substantially simultaneously.

According to another aspect, there is provided a method comprising increasing an antenna isolation between a first antenna panel and a second antenna panel by adjusting a radiation pattern associated with the first antenna panel and/or with the second antenna panel, and receiving a first signal via the first antenna panel and transmitting a second signal via the second antenna panel substantially simultaneously.

According to another aspect, there is provided a computer program comprising instructions for causing an apparatus to perform at least the following: increase an antenna isolation between a first antenna panel and a second antenna panel by adjusting a radiation pattern associated with the first antenna panel and/or with the second antenna panel, and to receive a first signal via the first antenna panel and transmit a second signal via the second antenna panel substantially simultaneously.

According to another aspect, there is provided a computer readable medium comprising program instructions for causing an apparatus to perform at least the following: increase an antenna isolation between a first antenna panel and a second antenna panel by adjusting a radiation pattern associated with the first antenna panel and/or with the second antenna panel, and to receive a first signal via the first antenna panel and transmit a second signal via the second antenna panel substantially simultaneously.

According to another aspect, there is provided a non-transitory computer readable medium comprising program instructions for causing an apparatus to perform at least the following: increase an antenna isolation between a first antenna panel and a second antenna panel by adjusting a radiation pattern associated with the first antenna panel and/or with the second antenna panel, and to receive a first signal via the first antenna panel and transmit a second signal via the second antenna panel substantially simultaneously.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIG. 2 illustrates duplexing options;

FIG. 3 illustrates examples of full-duplex schemes;

FIG. 4 illustrates a block diagram for a full-duplex enabled apparatus according to an exemplary embodiment;

FIG. 5 illustrates examples of bi-directional full-duplex schemes;

FIGS. 6 to 8 illustrate simulated measurement results;

FIG. 9 illustrates a radiation pattern;

FIG. 10 illustrates an architecture for an apparatus;

FIGS. 11a and 11b illustrate an architecture for an apparatus according to an exemplary embodiment;

FIGS. 12a and 12b illustrate an architecture for an apparatus according to an exemplary embodiment;

FIGS. 13 and 14 illustrate signalling diagrams according to exemplary embodiments;

FIGS. 15 to 17 illustrate flow charts according to exemplary embodiments;

FIGS. 18a and 18b illustrate radiation patterns according to an exemplary embodiment;

FIGS. 19a, 19b, 20 and 21 illustrate simulated measurement results according to exemplary embodiments;

FIGS. 22 and 23 illustrate apparatuses according to exemplary embodiments.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A) or new radio (NR, 5G), without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

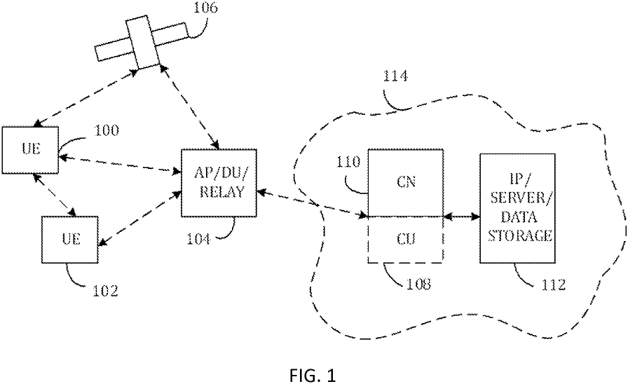

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB may be called uplink or reverse link and the physical link from the (e/g)NodeB to the user device may be called downlink or forward link. It should be appreciated that (e/g)NodeBs or their functionalities may be implemented by using any node, host, server or access point etc. entity suitable for such a usage.

A communication system may comprise more than one (e/g)NodeB, in which case the (e/g)NodeBs may also be configured to communicate with one another over links, wired or wireless, designed for the purpose. These links may be used for signaling purposes. The (e/g)NodeB may be a computing device configured to control the radio resources of communication system it is coupled to. The NodeB may also be referred to as a base station, an access point or any other type of interfacing device including a relay station capable of operating in a wireless environment. The (e/g)NodeB may include or be coupled to transceivers. From the transceivers of the (e/g)NodeB, a connection may be provided to an antenna unit that establishes bi-directional radio links to user devices. The antenna unit may comprise a plurality of antennas or antenna elements. The (e/g)NodeB may further be connected to core network 110 (CN or next generation core NGC). Depending on the system, the counterpart on the CN side may be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station.

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G may enable using multiple input - multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz - cmWave, below 6 GHz - cmWave - mmWave). One of the concepts considered to be used in 5G networks may be network slicing in which multiple independent and dedicated virtual sub-networks (network instances) may be created within the same infrastructure to run services that have different requirements on latency, reliability, throughput and mobility.

The current architecture in LTE networks may be fully distributed in the radio and fully centralized in the core network. The low latency applications and services in 5G may require to bring the content close to the radio which leads to local break out and multi-access edge computing (MEC). 5G may enable analytics and knowledge generation to occur at the source of the data. This approach may require leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It may also be possible that node operations will be distributed among a plurality of servers, nodes or hosts. Application of cloudRAN architecture may enable RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize satellite communication to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may also comprise other apparatuses, such as physical layer relay nodes or other network elements, etc. At least one of the (e/g)NodeBs or may be a Home(e/g)nodeB. Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In multilayer networks, one access node may provide one kind of a cell or cells, and thus a plurality of (e/g)NodeBs may be required to provide such a network structure.

For fulfilling the need for improving the deployment and performance of communication systems, the concept of “plug-and-play” (e/g)NodeBs may be introduced. A network which may be able to use “plug-and-play” (e/g)Node Bs, may include, in addition to Home (e/g)NodeBs (H(e/g)nodeBs), a home node B gateway, or HNB-GW (not shown in FIG. 1). A HNB Gateway (HNB-GW), which may be installed within an operator’s network, may aggregate traffic from a large number of HNBs back to a core network.

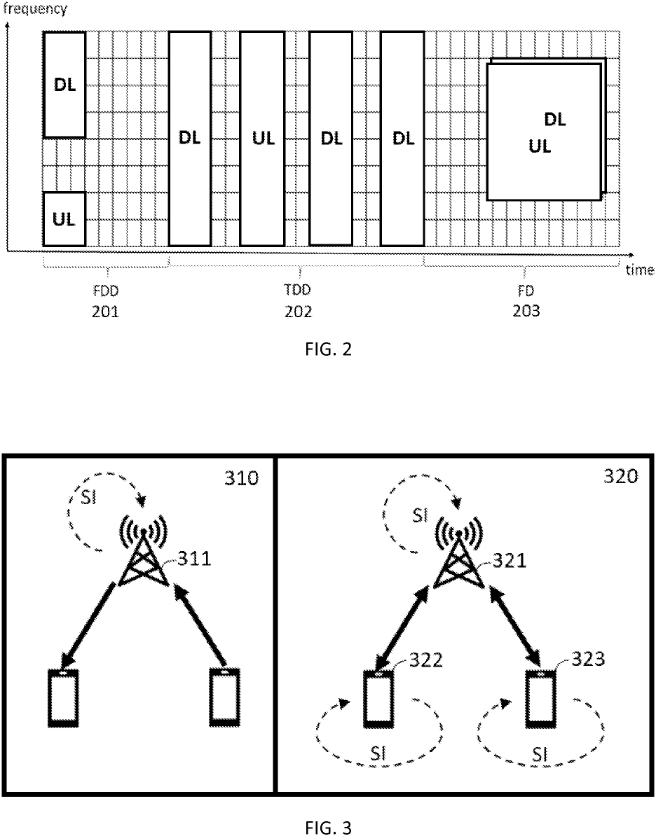

FIG. 2 illustrates duplexing options. As an example, the 3GPP NR Rel-15 specifications may support a frequency-division duplexing, FDD, mode 201, and a time-division duplexing, TDD, mode 202. In FDD mode 201, the transmitter and receiver operate using different frequencies. For paired bands FDD, non-overlapping carriers may be configured for downlink, DL, and uplink, UL, transmissions, respectively. However, network densification in ultra-reliable applications may pose requirements, which FDD may not meet. For operation in unpaired bands, a TDD mode 202 may be defined. TDD implies that a cell has either exclusive UL or DL, or no transmission, for each time instant. Hence, TDD does not support simultaneous UL and DL transmission.

For example, in ultra-reliable low latency communication, URLLC, and time-sensitive network, TSN, use cases, where multiple simultaneously active UEs may need to be served immediately, a cell may be required to have simultaneous UL and DL transmission to accommodate the strict latency, jitter, and/or ultra-reliability requirements for all users. A possible solution to meet these requirements may be full-duplex, FD, mode 203, which may double the throughput at ultra-low latency. FD enables a device to receive and transmit simultaneously in the same frequency band. For example, the device may use dedicated transmitter, TX, and receiver, RX, chains for transmission and reception in the same physical resource blocks, PRBs. However, a limitation with FD may be self-interference, SI, wherein the TX chain may leak energy onto the RX chain, thus contaminating the received signal. On the other hand, self-interference cancellation, SIC, techniques may be applied to reduce self-interference with FD. SIC may be introduced for example on the gNB side, or on both the gNB and UE sides, depending on the FD scheme in question. SIC may be performed for example as a combination of analog filtering and digital cancellation techniques.

FIG. 3 illustrates examples of full-duplex schemes with self-interference. Block 310 illustrates gNB FD, wherein self-interference, SI, may be present at a gNB 311. Block 320 illustrates bi-directional FD, wherein self-interference, SI, may be present both at a gNB 321 and at one or more UEs 322, 323.

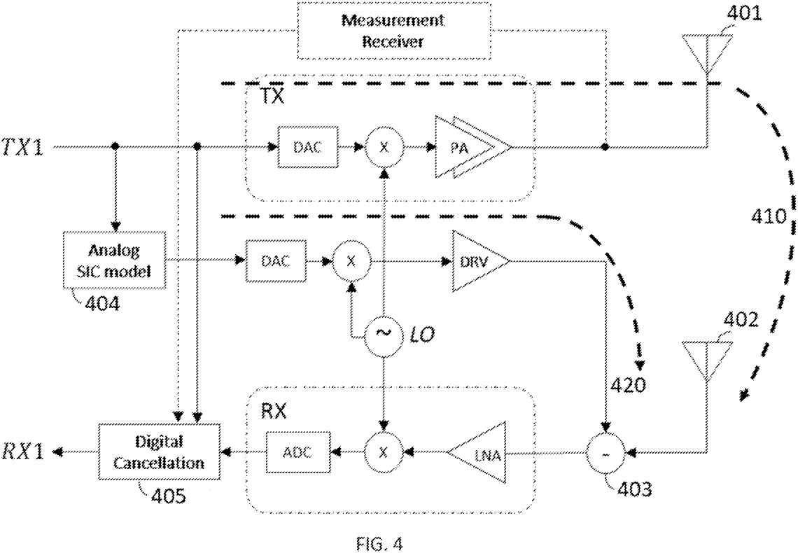

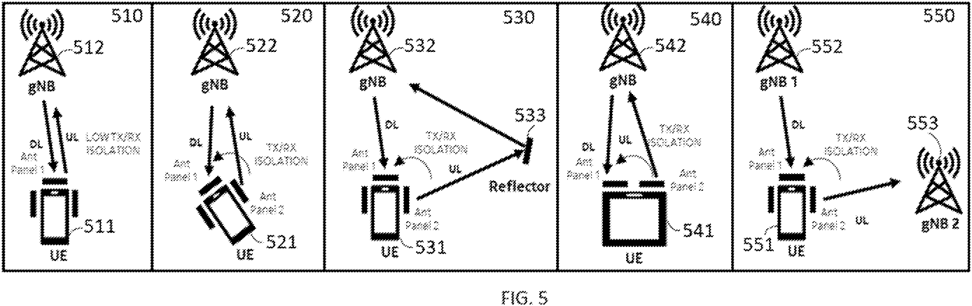

FIG. 4 illustrates a block diagram for a full-duplex enabled apparatus according to an exemplary embodiment. The apparatus may be comprised for example in a UE, which may also be referred to as a terminal device. The apparatus may comprise one or more power amplifiers, PA, one or more low-noise amplifiers, LNA, one or more analog-to-digital converters, ADC, one or more digital-to-analog converters, DAC, a local oscillator, LO, and/or a driver, DRV, which may also be referred to as a driver amplifier. A TX signal is transmitted at the TX antenna 401, leaking into the active RX chain via the RX antenna 402, as illustrated by arrow 410. The TX leakage residual at the RX antenna is cancelled at analog cleaning point 403 by a compensating signal 420 based on an analog SIC model 404. This may, for example, reduce the TX leakage residual and prevent digital SIC performance-degrading saturation of the LNA. Further TX residual cancellation is performed via a digital cancellation algorithm 405 in the RX baseband domain.

UE SIC performance may depend on the stability of high cancellation and/or isolation blocks being maintained over the operating conditions. For example, SIC performance may depend on sufficient UL and DL antenna isolation, low phase noise, TX power level, scheduled bandwidth, and/or cancellation processing power. The overall UE SIC cancellation gain may be achieved for example by TX and RX antenna isolation followed by an analog cancellation stage and a digital cancellation stage.

Antenna isolation may be defined for example as a measure of attenuation of radio frequency, RF, signals from one antenna to another. In other words, increased antenna isolation may result in reduced coupling, i.e. electromagnetic interaction, between the antennas. TX and RX antenna isolation for example approximately in the range of at least 45-50 dB may be beneficial for FD operation with a reasonable RX sensitivity.

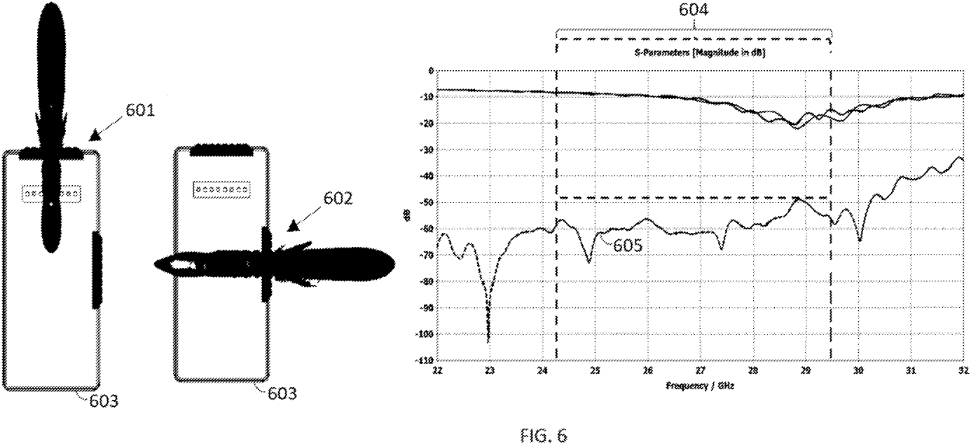

FIG. 5 illustrates examples of bi-directional full-duplex schemes. Block 510 illustrates a scheme, wherein a UE 511 uses a single mmWave antenna panel for the connection with the serving gNB 512. An antenna panel may also be referred to as an antenna array. In this scheme, the antenna UL and DL isolation may not be adequate to ensure no blockage and to obtain the required overall UL cancellation gain in the UE receiver.

In some exemplary embodiments, a mmWave UE may be equipped with more than one antenna panel to approach omni-directional monitoring capability. Blocks 520, 530 and 540 illustrate three possible schemes with the UE supporting FD towards the serving gNB using two separate UL and DL antenna panels according to some exemplary embodiments. Block 520 illustrates a direct connection between a UE 521 and a gNB 522 with the UE using two antenna panels. Block 530 illustrates a connection between a UE 531 and a gNB 532 via a reflector 533 with the UE using two antenna panels. Block 540 illustrates a connection between a UE 541 and a gNB 542 with the UE using two co-sided antenna panels. Block 550 illustrates a scheme with a UE 551 supporting full-duplex via separate UL and DL antenna panels in a multiple transmission and reception, multi-TRP, setup comprising a first gNB 552 and a second gNB 553. A common requirement for the schemes illustrated in blocks 520, 530, 540 and 550 may be high enough UE panel-to-panel antenna isolation to support FD operation with UL and DL supported on separate antenna panels.

FIG. 6 illustrates simulated measurement results. FIG. 6 illustrates antenna isolation obtained at the 28 GHz band, i.e. comprising the n257, n258 and n261 bands from 24.25 GHz to 29.5 GHz, for two 1×8 element UE antenna panels 601, 602 mounted at the top and at the side of a UE 603 with beams steered in boresight direction for both panels. The required impedance bandwidth 604 at the UE may be 24.25 GHz to 29.5 GHz. The results may indicate that in this configuration the antenna isolation may be high enough to support FD operation. As indicated by line 605, the antenna isolation may be more than 47 dB in the range 604, and approximately 57 dB at 28 GHz.

However, the UE may be moving in the field. Furthermore, the schemes illustrated in blocks 520, 530, 540 and 550 of FIG. 5 with beams steered towards the same direction or in opposite directions may need to be considered as well.

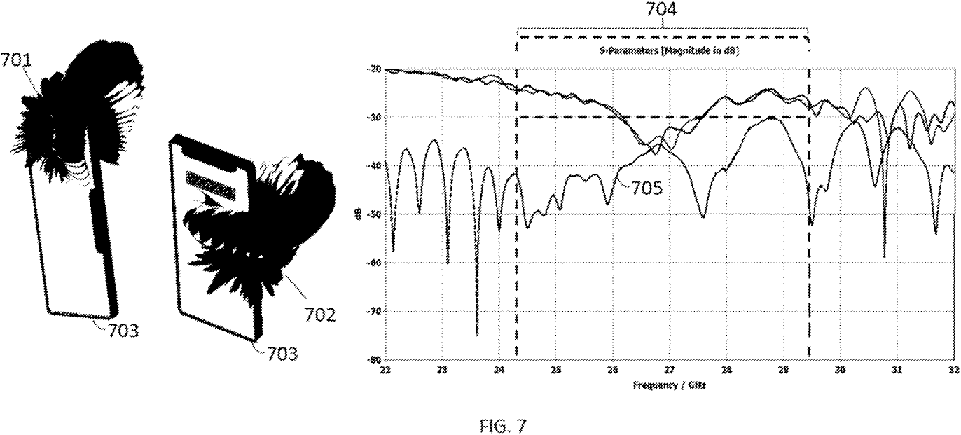

FIG. 7 illustrates simulated measurement results, wherein the antenna isolation is simulated for beams at two antenna panels 701, 702 of a UE 703 steered towards each other with a +45 degrees steering angle. The required impedance bandwidth 704 at the UE may be 24.25 GHz to 29.5 GHz. As indicated by line 705, the antenna isolation may be more than 30 dB in the range 704, and approximately 43 dB at 28 GHz.

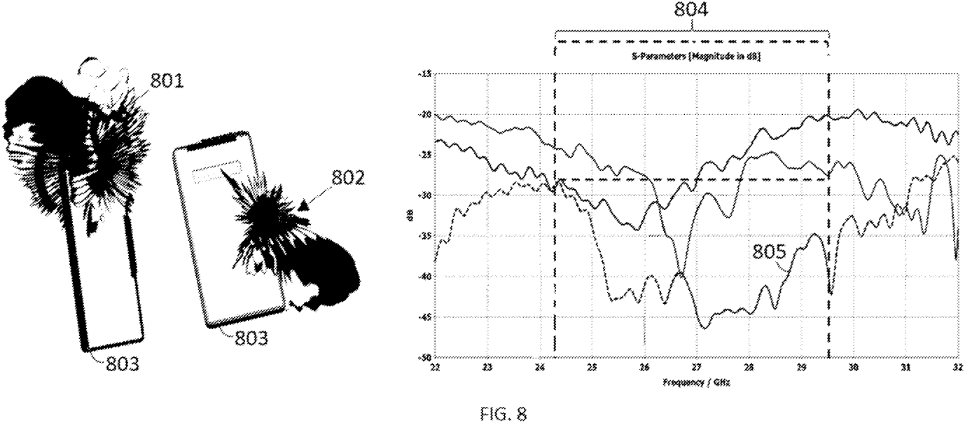

FIG. 8 illustrates simulated measurement results, wherein the isolation is simulated for beams at two antenna panels 801, 802 of a UE 803 steered away from each other with a -45 degrees steering angle. The required impedance bandwidth 804 at the UE may be 24.25 GHz to 29.5 GHz. As indicated by line 805, the antenna isolation may be more than 28 dB in the range 804, and approximately 45 dB at 28 GHz.

Based on the simulations illustrated in FIGS. 7 and 8, the isolation may be reduced to approximately 30 dB for some frequencies in both of these cases. This may not meet the requirements for FD operation.

Some exemplary embodiments provide an antenna panel beamforming concept for enhanced panel-to-panel antenna isolation in order to enable FD operation for example at millimeter wave, mmWave, frequencies. In an exemplary embodiment, antenna isolation between two antenna panels located at some physical distance away from each other may be increased by adjusting the radiation pattern of an antenna panel to cause lower radiation in the direction of the other antenna panel, and/or vice versa. The target direction of this low radiation adjustment may be fixed and known by the UE, and thus isolation-optimized radiation patterns may be obtained via UE characterization. It may be beneficial to obtain and maintain an antenna isolation of at least 50 dB by the mutual panel radiation minimization. In some exemplary embodiments, the main beam direction and gain of the two antenna panels may be only slightly impacted by these radiation adjustments.

A radiation pattern may refer to the variation of the power of the radio waves radiated by an antenna as a function of the direction away from the antenna, i.e. the way the antenna distributes its energy in space. A radiation pattern may be defined for example as a mathematical function or graphical representation of the radiation properties of the antenna as a function of space coordinates.

In some exemplary embodiments, the UE panel-to-panel distance may be large enough for panel-to-panel interaction to not be considered as a near-field coupling at mmWave frequencies. In other words, the physical distance between two antenna panels may be equal to multiple wavelengths, for example at least two wavelengths. The wavelength is inversely proportional to the used carrier frequency. For example, at 30 GHz the wavelength is approximately 1 cm. Therefore, if two antenna panels are for example at a distance of approximately 3 to 4 cm away from each other, at 30 GHz this distance equals approximately 3 to 4 wavelengths, which may not be considered as a near-field coupling.

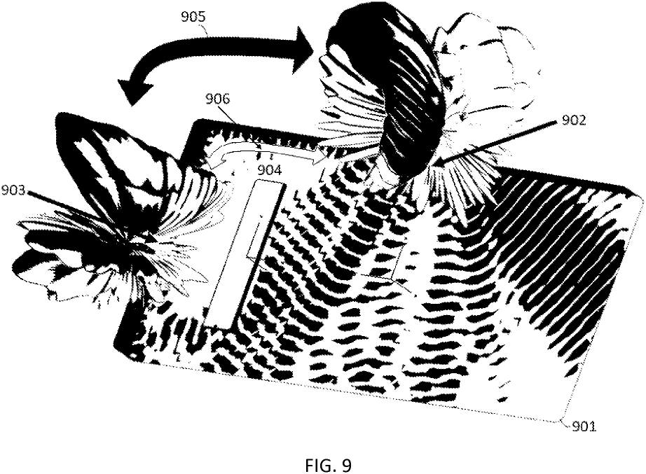

FIG. 9 illustrates optimization of a radiation pattern to limit current flow between two FD-configured antenna panels according to an exemplary embodiment. There may be radiation coupling 905 and surface current coupling 906 between the antenna panels, wherein coupling refers to electromagnetic interaction. In this exemplary embodiment, two antenna panels 902, 903 of a UE 901 are active with main beam steering direction towards the same physical point, for example the serving gNB, and with the radiation pattern of each UE local antenna panel optimized for low radiation in the direction of the other antenna panel. This way, the UE local current flow in the area 904 between the antenna panels 902, 903 may be reduced, and thus the isolation between the antenna panels increased. In FIG. 9, high current flows are illustrated in black, and white areas indicate low current.

Table 1 below depicts a schematic representation of a FD-specific mmWave antenna array beamforming codebook structure according to an exemplary embodiment. The antenna codebook may be, for example, a data structure such as a table. The antenna codebook may be comprised for example in an internal memory of a UE, or obtained from a base station. The codebook structure may support maximized antenna panel-to-panel isolation for dual antenna panel UL and DL full-duplex operation. The FD antenna array codebook entries may be derived for example based on antenna radiation pattern analysis and/or UE characterization. The antenna array codebook structure may allow, for any beam steering angle, to select either a TDD codebook entry or a FD mode codebook entry based on the active dual panel FD mode companion antenna array to ensure minimum radiation towards the companion antenna array.

TABLE 1

| Beam steering angle | Main array | TDD | FD: Companion array | | |
|---|---|---|---|---|---|
| | | | Array #1 | Array #2 | Array #n |
| #1 | Array #1 | Codebook #1,1 | - | Codebook #1,1,2 | Codebook #1,1,n |
| | Array #2 | Codebook #1,2 | Codebook | - | Codebook |
| | | | #1,2,1 | | #1,2,n |
| | Array #n | Codebook #1,n | Codebook # 1,n, 1 | Codebook #1,n,2 | - |
| #2 | Array #1 | Codebook #2,1 | - | Codebook #2,1,2 | Codebook #2,1,n |
| | Array #2 | Codebook #2,2 | Codebook #2,2,1 | - | Codebook #2,2,n |
| | Array #n | Codebook #2,n | Codebook #2,n,1 | Codebook #2,n,2 | - |
| #x | Array #1 | Codebook #x,1 | - | Codebook #x,1,2 | Codebook #x,1,n |
| | Array #2 | Codebook #x,2 | Codebook #x,2,1 | - | Codebook #x,2,n |
| | Array #n | Codebook #x,n | Codebook #x,n,1 | Codebook #x,n,2 | - |

An example for TDD mode using only the first antenna array is depicted in Table 2 below, wherein the associated codebook entries vs. beam steering angle are bolded.

TABLE 2

| Beam steering angle | Main array | TDD | FD: Companion array | | |
|---|---|---|---|---|---|
| | | | Array #1 | Array #2 | Array #n |
| #1 | Array #1 | Codebook #1,1 | - | Codebook #1,1,2 | Codebook #1,1,n |
| | Array #2 | Codebook #1,2 | Codebook #1,2,1 | - | Codebook #1,2,n |
| | Array #n | Codebook #1,n | Codebook #1,n,1 | Codebook #1,n,2 | - |
| #2 | Array #1 | Codebook #2,1 | - | Codebook #2,1,2 | Codebook #2,1,n |
| | Array #2 | Codebook #2,2 | Codebook | - | Codebook |
| | | | #2,2,1 | | #2,2,n |
| | Array #n | Codebook #2,n | Codebook #2,n,1 | Codebook #2,n,2 | - |
| #x | Array #1 | Codebook #x,1 | - | Codebook #x,1,2 | Codebook #x,1,n |
| | Array #2 | Codebook #x,2 | Codebook #x,2,1 | - | Codebook #x,2,n |
| | Array #n | Codebook #x,n | Codebook #x,n,1 | Codebook #x,n,2 | - |

An example for dual panel FD mode using the first and second antenna array is depicted in Tables 3 and 4 below. The two active UL and DL antenna arrays may be identified for example based on gNB visibility and/or link budget. The appropriate codebook entries for the first and second antenna array may be identified for example by the selected steering angle, as indicated by the bolded cells in Tables 3 and 4.

TABLE 3

| Beam steering angle | Main array | TDD | FD: Companion array | | |
|---|---|---|---|---|---|
| | | | Array #1 | Array #2 | Array #n |
| #1 | Array #1 | Codebook #1,1 | - | Codebook #1,1,2 | Codebook #1,1,n |
| | Array #2 | Codebook #1,2 | Codebook #1,2,1 | - | Codebook #1,2,n |
| | Array #n | Codebook #1,n | Codebook #1,n,1 | Codebook #1,n,2 | - |
| #2 | Array #1 | Codebook #2,1 | - | Codebook #2,1,2 | Codebook #2,1,n |
| | Array #2 | Codebook #2,2 | Codebook #2,2,1 | - | Codebook #2,2,n |
| | Array #n | Codebook #2,n | Codebook #2,n,1 | Codebook #2,n,2 | - |
| #x | Array #1 | Codebook #x,1 | - | Codebook | Codebook |
| | | | | #x,1,2 | #x,1,n |
| | Array #2 | Codebook #x,2 | Codebook #x,2,1 | - | Codebook #x,2,n |
| | Array #n | Codebook #x,n | Codebook #x,n,1 | Codebook #x,n,2 | - |

TABLE 4

| Beam steering angle | Main array | TDD | FD: Companion array | | |
|---|---|---|---|---|---|
| | | | Array #1 | Array #2 | Array #n |
| #1 | Array #1 | Codebook #1,1 | - | Codebook #1,1,2 | Codebook #1,1,n |
| | Array #2 | Codebook #1,2 | Codebook #1,2,1 | - | Codebook #1,2,n |
| | Array #n | Codebook #1,n | Codebook # 1,n,1 | Codebook #1,n,2 | - |
| #2 | Array #1 | Codebook #2,1 | - | Codebook #2,1,2 | Codebook #2,1,n |
| | Array #2 | Codebook #2,2 | Codebook #2,2,1 | - | Codebook #2,2,n |
| | Array #n | Codebook #2,n | Codebook #2,n,1 | Codebook #2,n,2 | - |
| #x | Array #1 | Codebook #x,1 | - | Codebook #x,1,2 | Codebook #x,1,n |
| | Array #2 | Codebook #x,2 | Codebook #x,2,1 | - | Codebook #x,2,n |
| | Array #n | Codebook #x,n | Codebook #x,n,1 | Codebook #x,n,2 | - |

In order for a UE to support dual antenna panel FD operation, the RF transceiver is required to support simultaneous UL and DL traffic, and not only TDD operation. In addition, the RF front-end may be required to support switching between UL and DL traffic via one antenna panel, and UL and DL traffic via two separate antenna panels. In other words, to support switching between TDD mode and FD mode.

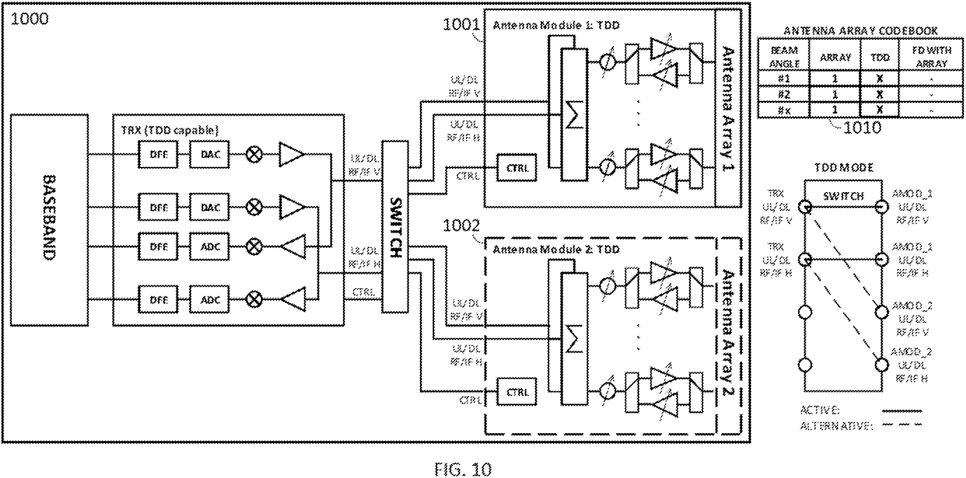

FIG. 10 illustrates an architecture for an apparatus 1000 and an associated antenna array codebook 1010. The apparatus 1000 may be comprised for example in a UE, and the apparatus 1000 may comprise a plurality of analog-to-digital converters, ADC, a plurality of digital-to-analog converters, DAC, a plurality of digital front ends, DFE, and one or more summing units, Σ. More precisely, FIG. 10 illustrates an example of a TDD-only mmWave RF lineup with two antenna panels. A single transceiver, TRX, is connected via a switch to either a first antenna module 1001 or a second antenna module 1002 using shared UL and DL interfaces for vertical, V, and horizontal, H, antenna polarization signals. This configuration may not support FD operation, and thus changes to the radio implementation may be required for enabling FD.

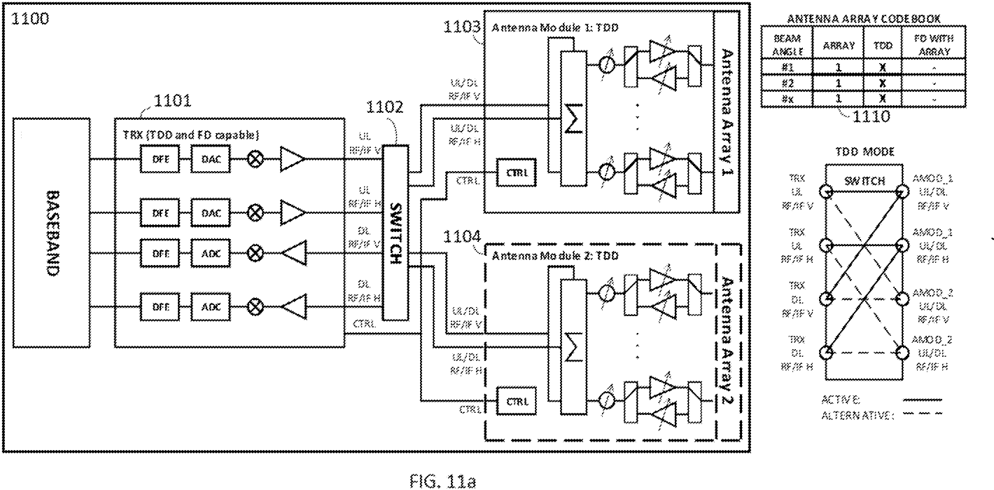

FIGS. 11a and 11b illustrate an architecture for an apparatus 1100 according to an exemplary embodiment. The apparatus 1100 supports switching between dual antenna panel FD and single antenna panel TDD, with corresponding codebooks 1110, 1111, 1112 selected for each mode. The apparatus comprises a TRX 1101 capable of FD and TDD, a signal interface switch 1102, and at least two antenna modules 1103, 1104. The apparatus 1100 may further comprise a plurality of analog-to-digital converters, ADC, a plurality of digital-to-analog converters, DAC, a plurality of digital front ends, DFE, and one or more summing units, Σ. FIG. 11a illustrates TDD mode, and FIG. 11b illustrates FD mode. In TDD mode, the switch 1102 is combining the UL and DL signals from the TRX 1101 for the active antenna module 1103. In FD mode, the switch 1102 is routing the simultaneously active UL and DL signals from the TRX 1101 to each of the two active antenna modules 1103, 1104. It may be beneficial to have RX and TX isolation within the TRX 1101 and in the switch 1102 in order to not compromise the obtained panel-to-panel isolation. The apparatus 1100 may be comprised for example in a UE.

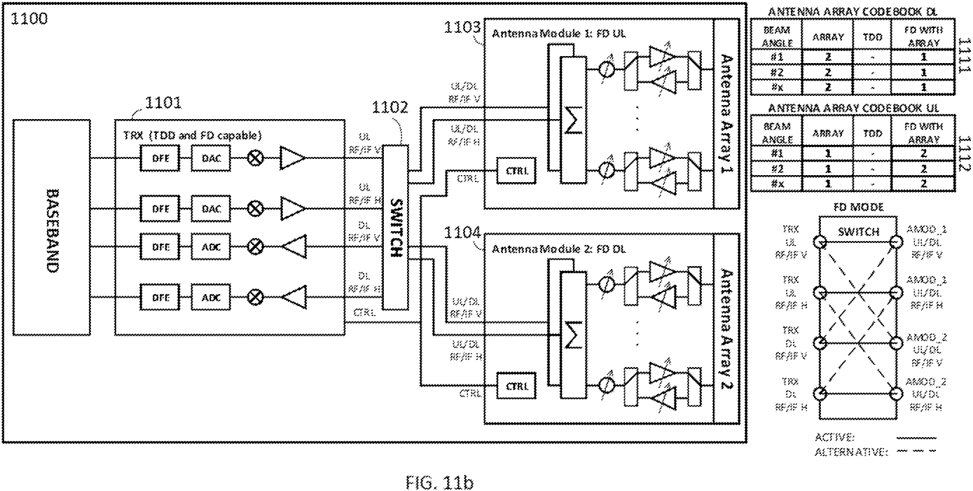

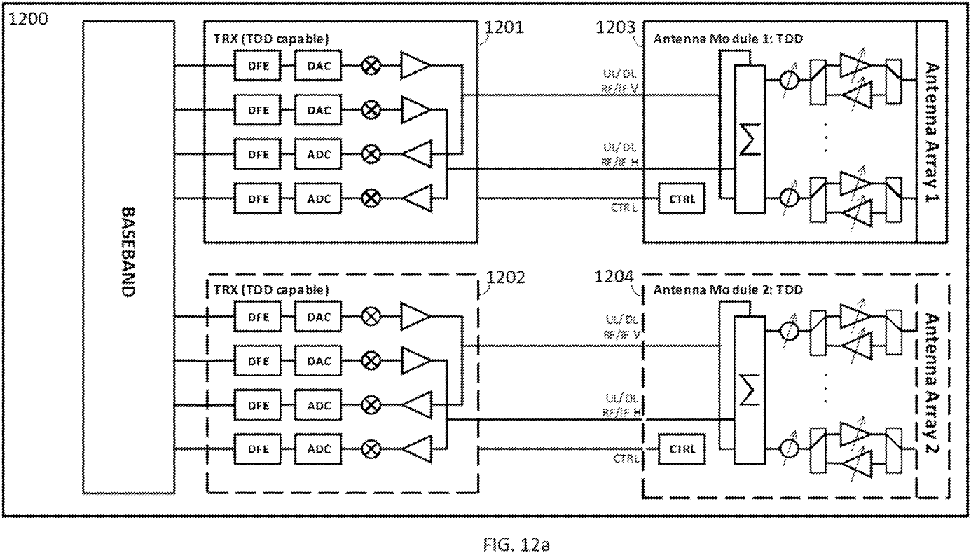

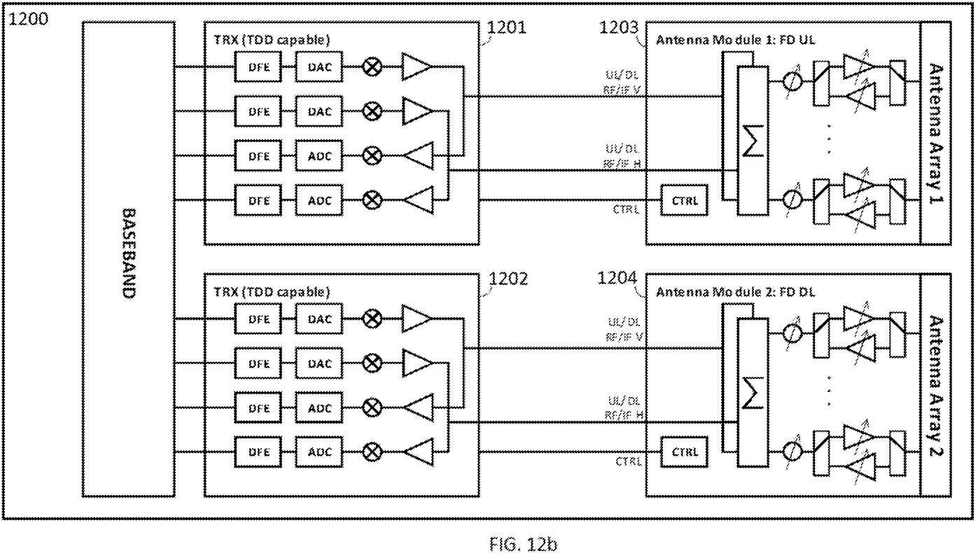

FIGS. 12a and 12b illustrate an architecture for an apparatus 1200 according to an exemplary embodiment. The apparatus supports switching between dual antenna panel FD and single antenna panel TDD. The apparatus 1200 comprises two TDD capable TRXs 1201, 1202, and at least two antenna modules 1203, 1204, with no signal interface switch. The apparatus 1200 may further comprise a plurality of analog-to-digital converters, ADC, a plurality of digital-to-analog converters, DAC, a plurality of digital front ends, DFE, and one or more summing units, Σ. FIG. 12a illustrates TDD mode, and FIG. 12b illustrates FD mode. In TDD mode, one TRX 1201 is active and connected directly to the active antenna module 1203. In FD mode, two TRXs 1201, 1202 are active, each connected directly to one active antenna module 1203, 1204 with one RF chain supporting the UL, and one RF chain supporting the DL. The apparatus 1200 may be comprised for example in a UE.

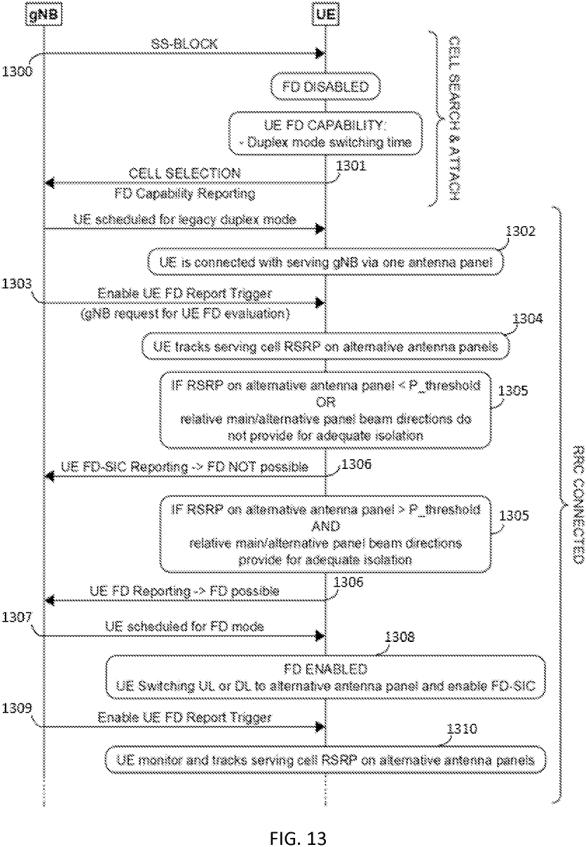

The serving base station, for example a gNB, may schedule the UE for FD mode when at least two UE antenna panels are connected to the gNB through two channels with an acceptable link budget, for example according to the schemes illustrated in blocks 520, 530 and 540 in FIG. 5. Such a procedure for dynamic UE switching between legacy duplexing mode and FD mode is illustrated in the signalling diagram of FIG. 13, according to an exemplary embodiment.

Referring to FIG. 13, in step 1300, a base station, for example a gNB, may transmit one or more synchronization signal blocks, SS-blocks, to a UE. Full-duplex may be initially disabled at the UE, but the UE may have FD capability. In step 1301, the UE indicates its FD capability to the gNB during cell camping, and the gNB subsequently schedules the UE for a legacy duplexing mode, for example TDD. In step 1302, the UE enters radio resource control, RRC, connected mode in the legacy duplexing mode, for example TDD. In step 1303, the gNB requests the UE to analyze if FD is feasible by enabling a FD report trigger. In step 1304, the UE starts a search for the serving gNB on one or more alternative antenna panels, and measures for example reference signal received power, RSRP, and/or some other quality indicator, such as signal-to-interference-plus-noise ratio, SINR, reference signal received quality, RSRQ, and/or received signal strength indicator, RSSI, associated with the serving cell on the one or more alternative antenna panels. In step 1305, the UE evaluates if the beam steering angles for the relevant antenna panels allow for adequate panel-to-panel antenna isolation based on a pre-defined FD mode antenna beamforming codebook. In addition, the UE may evaluate, for example, if the measured RSRP is above or below a pre-defined threshold value. In step 1306, the UE reports back to the gNB with the FD feasibility verdict, for example by transmitting an indication that FD is possible or not possible, based for example on the local RSRP and panel-to-panel antenna isolation assessment. In step 1307, upon a successful FD verdict from the UE, the gNB schedules the UE for FD mode. In step 1308, upon establishment of a link to the gNB via the second antenna panel, the UE selects and switches either UL or DL to the second antenna panel, and enables FD SIC mode. In step 1309, the gNB may again enable the FD report trigger, and in step 1310 the UE may monitor and track a quality indicator, for example RSRP, associated with the serving cell on one or more alternative antenna panels.

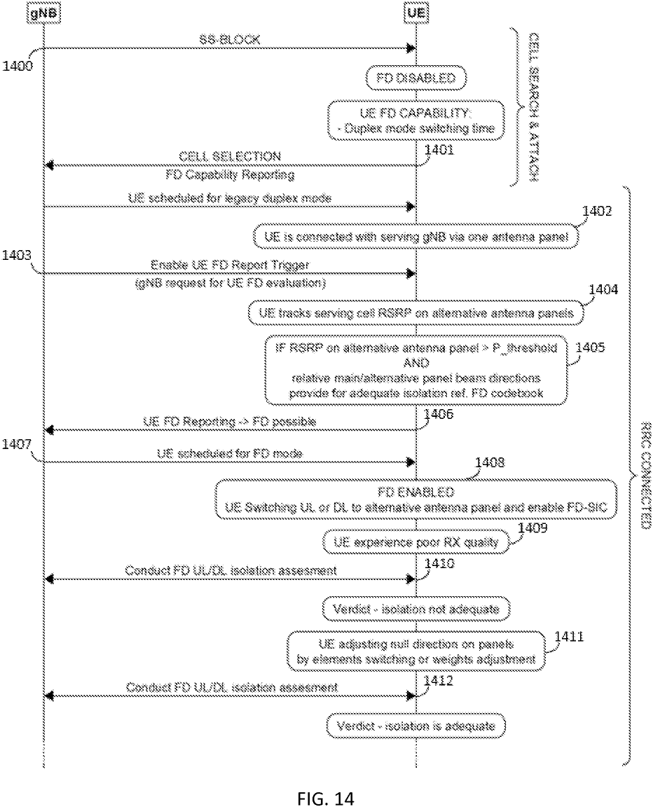

Since the direction of the other antenna panel may be known, it may be possible to pre-define specific high panel-to-panel isolation codebook entries comprising for example radiation pattern configurations for FD operation. In the field, the low radiation direction may be impacted for example by UE environment dynamics etc., and a radiation pattern adjustment capability may be required to maintain the isolation at pre-defined levels. This may be accomplished for example by a procedure illustrated in the signalling diagram of FIG. 14, according to an exemplary embodiment.

Referring to FIG. 14, in step 1400, a base station, for example a gNB, may transmit one or more synchronization signal blocks, SS-blocks, to a UE. Full-duplex may be initially disabled at the UE, but the UE may have FD capability. In step 1401, the UE indicates its FD capability to the gNB during cell camping, and the gNB subsequently schedules the UE for a legacy duplexing mode, for example TDD. In step 1402, the UE enters RRC connected mode in the legacy duplexing mode, for example TDD. In step 1403, the gNB requests the UE to analyze if FD is feasible by enabling a FD report trigger. In step 1404, the UE starts a search for the serving gNB on one or more alternative antenna panels, and measures for example RSRP and/or some other quality indicator, such as SINR, RSRQ, and/or RSSI, associated with the serving cell on the one or more alternative antenna panels. In step 1405, the UE evaluates if the beam steering angles for relevant antenna panels allow for adequate panel-to-panel antenna isolation based on a pre-defined FD mode antenna beamforming codebook. In addition, the UE may evaluate, for example, if the measured RSRP is above or below a pre-defined threshold value. In step 1406, the UE reports back to the gNB with a positive FD feasibility verdict based on the local RSRP and panel-to-panel isolation assessment. In step 1407, upon a successful FD verdict from the UE, the gNB schedules the UE in FD mode. In step 1408, upon establishment of a link to the gNB via the second antenna panel, the UE selects and switches either UL or DL to the second antenna panel and enables FD SIC mode. In step 1409, the UE experiences poor reception quality, for example based on RSRP, and in step 1410 the UE triggers an UL and DL isolation verification, or assessment, procedure. In step 1411, based on an isolation not adequate verdict from step 1410, the UE adjusts the low radiation direction, or the directions of the nulls, on the active antenna panels for example by switching off one or more antenna elements comprised in the active antenna panels and/or by adjusting one or more weights, such as an amplitude and/or phase. Each of the antenna panels may comprise a plurality of individual antenna elements. Step 1411 may be performed for example by an algorithm that may be UE implementation specific. The algorithm may comprise for example a black box search and/or it may make use of a-priori knowledge about radiation pattern impact due to specific events or condition changes. In step 1412, the UE may re-trigger the UL and DL isolation verification procedure in order to confirm that the obtained antenna isolation is adequate. Alternatively, in some exemplary embodiments the UE may simply rely on the improved RX quality experienced after the update in step 1411 without continuing to step 1412.

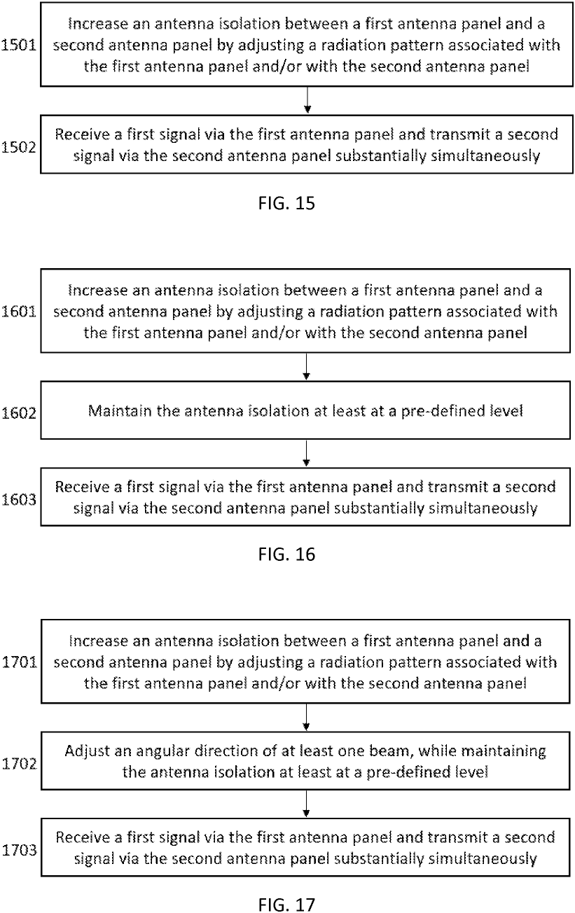

FIG. 15 illustrates a flow chart according to an exemplary embodiment. Referring to FIG. 15, an antenna isolation between a first antenna panel and a second antenna panel is increased 1501 by adjusting a radiation pattern associated with the first antenna panel and/or with the second antenna panel. The radiation pattern may be adjusted for example by turning off power, or adjusting a power level, on one or more antenna elements comprised in the first antenna panel and/or in the second antenna panel, and/or by adjusting an amplitude and/or phase associated with the one or more antenna elements. Both the first antenna panel and the second antenna panel may comprise a plurality of antenna elements. In step 1502, a first signal is received via the first antenna panel and a second signal is transmitted via the second antenna panel simultaneously, or at least substantially simultaneously, i.e. in full-duplex mode. In other words, the first signal is received via the first antenna panel and the second signal is transmitted via the second antenna panel during the same time instant, or at least partially during the same time instant.

FIG. 16 illustrates a flow chart according to another exemplary embodiment. Referring to FIG. 16, an antenna isolation between a first antenna panel and a second antenna panel is increased 1601 by adjusting a radiation pattern associated with the first antenna panel and/or with the second antenna panel. The antenna isolation is maintained 1602 at least at a pre-defined level, or value, for example 45 dB or 50 dB, by adjusting the radiation pattern. In step 1603, a first signal is received via the first antenna panel and a second signal is transmitted via the second antenna panel simultaneously, or at least substantially simultaneously.

FIG. 17 illustrates a flow chart according to another exemplary embodiment. Referring to FIG. 17, an antenna isolation between a first antenna panel and a second antenna panel is increased 1701 by adjusting a radiation pattern associated with the first antenna panel and/or with the second antenna panel. An angular direction of at least one beam, for example a main beam, associated with the first antenna panel and/or with the second antenna panel is adjusted 1702, while maintaining the antenna isolation at least at a pre-defined level, or value, for example 45 dB or 50 dB. In step 1703, a first signal is received via the first antenna panel and a second signal is transmitted via the second antenna panel simultaneously, or at least substantially simultaneously.

The functions and/or steps described above by means of FIGS. 13-17 are in no absolute chronological order, and some of them may be performed simultaneously or in an order differing from the described one. Other functions and/or steps may also be executed between them or within them.

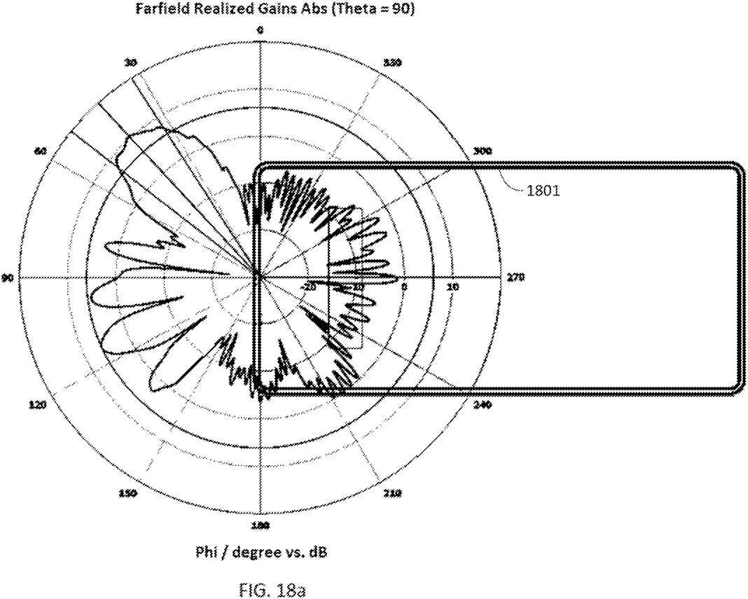

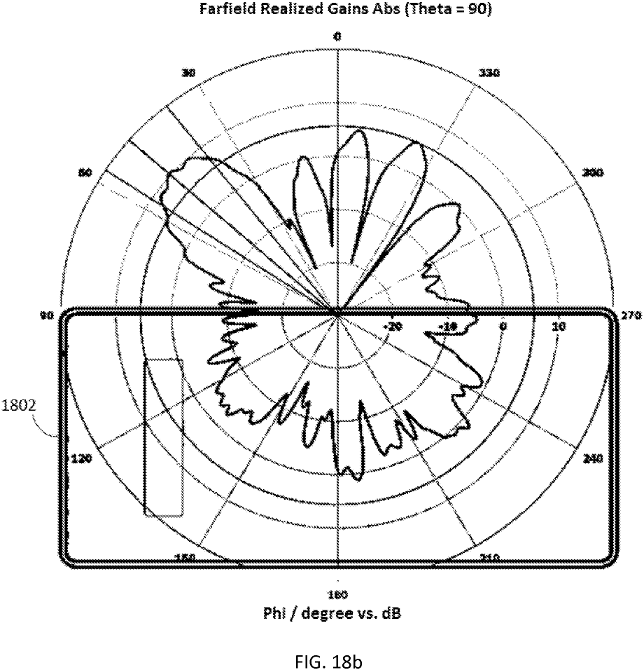

FIGS. 18a and 18b illustrate isolation optimization at 28 GHz frequency according to an exemplary embodiment, wherein panel-to-panel spacing is high enough to avoid near field coupling alone. FIG. 18a illustrates a radiation pattern for a first antenna panel steered at a -45 degree angle, wherein a second antenna panel 1801 is at a 0 degree angle. FIG. 18b illustrates a radiation pattern for the second antenna panel steered at a +45 degree angle, wherein the first antenna panel 1802 is at a 90 degree angle. FIGS. 18a and 18b represent a UE oriented so that both antenna panels may see the serving gNB, thus corresponding for example with the scheme illustrated in block 520 of FIG. 5. It may be seen in FIGS. 18a and 18b that both radiation patterns may not be optimized for a null in the direction of the other antenna panel, and the obtained isolation at 28 GHz in this configuration may be approximately 43 dB. However, the directions of the nulls may be controlled by adjusting the weights, for example amplitude and/or phase, on the individual antenna elements comprised in the antenna panel. In addition, since the direction of the other antenna panel is known, it may be possible to pre-define specific codebook entries, for example radiation pattern configurations, for FD operation.

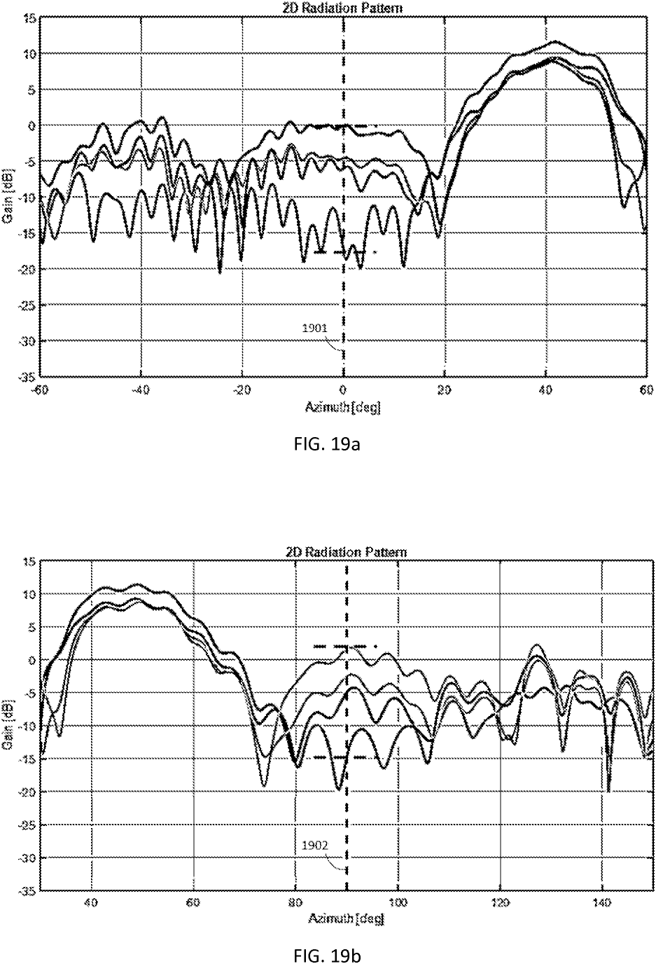

FIGS. 19a and 19b illustrate simulated measurement results for four different antenna panel settings according to some exemplary embodiments, wherein the direction of the main beam is the same, but the characteristics of the sidelobes and nulls are different. FIG. 19a illustrates simulated measurement results for a first antenna panel steered at a 90 degree angle, wherein the main beam of the first antenna panel is directed towards the gNB at +45 degrees. From FIG. 19a, it may be seen that the power from the first antenna panel to the direction 1901 of the second antenna panel, i.e. 0 degrees, may be affected by up to 18 dB for these four examples of configured radiation patterns, where the direction of the main beam is maintained while the direction of the nulls is varied. FIG. 19b illustrates simulated measurement results for the second antenna panel steered at a 0 degree angle, wherein the main beam of the second antenna panel is directed towards the gNB at +45 degrees. From FIG. 19b, it may be seen that the power from the second antenna panel to the direction 1902 of the first antenna panel, i.e. 90 degrees, may be affected by up to 17 dB for these four examples of configured radiation patterns, where the direction of the main beam is maintained while the direction of the nulls is varied.

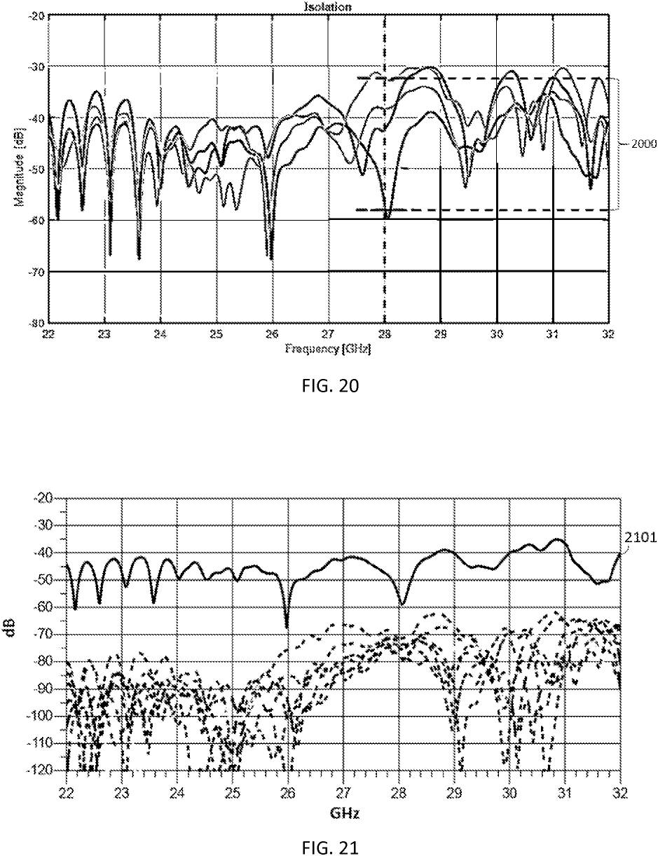

FIG. 20 illustrates simulated measurement results for four different antenna panel settings according to an exemplary embodiment using combined isolation optimization between different antenna panels on the same platform, or apparatus. The radiation patterns are simulated at 28 GHz, as an example. From FIG. 20, it may be seen that the combined isolation between the two antenna panels may be improved from 32 dB to 57 dB by optimizing the radiation patterns of the two antenna panels with an aim to achieve a lower power towards the other panel, while maintaining the main beam(s) of the antenna panels in the desired direction. The isolation adjustability 2000 may be approximately 25-30 dB.

In an exemplary embodiment, the amount of coupling from one antenna panel to the other antenna panel may be significantly reduced for example in a radiation pattern configuration, where the power for example at antenna elements #2 and #7 is zero, when compared to a configuration having equal power on all antenna elements comprised in the antenna panel. Alternatively or additionally, adjusting of the antenna panel weights may be performed, wherein a similar effect may be achieved by adjusting for example the phase of each element or a combination of both. Setting the power on elements #2 and #7 to zero is used as an exemplary embodiment.

The per element isolation on one antenna panel towards the combined second panel may also have an effect in ensuring that the individual LNAs connected directly through a switch to each element are not saturated by the TX power radiated from the second panel, since LNA saturation may prevent efficient digital SIC in the UE receiver.

FIG. 21 illustrates simulated measurement results according to an exemplary embodiment. This exemplary embodiment uses per element isolation from one antenna panel towards the combined second panel with elements #2 and #7 turned off, i.e. at zero power. The antenna panel comprises a plurality of antenna elements, for example 8 elements. In FIG. 21, the solid line 2101 indicates combined isolation at both antenna panels, and the dashed lines indicate per element isolation from one panel toward the combined second panel. From FIG. 21, it may be seen that the single antenna elements may experience higher isolation than for the combined panels. As such, the panel-to-panel isolation optimization may be performed by observation of the combined panel radiation pattern.

A technical advantage provided by some exemplary embodiments may be that they may provide improved antenna isolation, for example at least 50 dB, between two antenna panels in order to enable full-duplex capability at the UE without changing the desired direction of the main beam of the antenna. The improved antenna isolation may be maintained from antenna to baseband for example in a single TRX and antenna module lineup despite crosstalk between the antenna module and the printed circuit board, PCB. Thus, latency may be reduced and/or cell capacity may be increased. This may optimize the PRB utilization for example to cope with network densification and/or stringent latency requirements. Furthermore, a base station, such as a gNB, may be allowed to dynamically schedule the UE for TDD or FD duplexing mode. Some exemplary embodiments may be used for example for URLLC and/or TSN services to meet the associated latency requirements, or in dense 5G networks to optimize resource utilization. Moreover, by using two separate antenna panels for UL and DL, existing TDD lineups for example in combined mmWave TRX and antenna modules may be reused, i.e. one for DL and one for UL, while maintaining the required UL and DL isolation for FD operation from the antennas to the baseband.

A mmWave environment may be characterized with a line-of-sight, LOS, component and/or one or more non-line-of-sight, NLOS, components, wherein the NLOS component may be stronger, measured for example by RSRP, than the LOS component due to high environmental attenuation at mmWave frequencies. For example, two or three strong channel components at mmWave frequencies may be utilized in order to enable FD operation at the base station, for example a gNB, and at the UE. FD operation may be activated when the channel conditions support it, and configured for example in the following two ways depending on the channel conditions: 1) FD with a single strong channel component, or 2) FD with multiple strong channel components.

In an exemplary embodiment, a base station, such as a gNB, may use two co-located antenna panels for TX and RX. This may enable high TX to RX isolation in order to support FD. Thus, the base station may be capable of utilizing multiple channel components in an optimal configuration with maximum gain in both directions, or in the same direction.

If the environment has a single strong channel component, then it may be beneficial to configure the UE for a split antenna array configuration. However, by dividing the UE array into a TX and RX part, a loss of antenna gain of approximately 4 to 5 dB may occur. Therefore, the split array configuration, may be beneficial if the second-best channel component is approximately at least 5 dB lower than the main channel component.

However, if the second-best channel component is less than 5 dB below the main component, then it may be beneficial to configure the UE to use two antenna panels for FD operation, as described in some exemplary embodiments above. Using two different antenna panels at the UE may keep the full antenna gain for both UL and DL.

A single strong channel component may not be reciprocal in DL and UL, and thus one direction may be significantly affected by interference, which may not be optimal for FD operation. However, this may be counteracted by utilizing a weaker second-best channel component for either UL or DL, depending on the origin of the interfering signal, since a weaker RSRP channel component may have a stronger signal-to-interference-plus-noise ratio, SINR, value.

Some exemplary embodiments may be used for multi-TRP operation for example with two different non co-located gNBs. Multi-TRP operation may increase the probability of having two or more strong channel components at the UE, and thus increase the advantage of using two different antenna panels at the UE for FD operation.

In some exemplary embodiments, the UE formfactor for specific applications may allow the UE to comprise two antenna panels mounted co-sided, as illustrated for example in block 540 of FIG. 5. Such a configuration may be used advantageously even when only a single strong signal component exists.

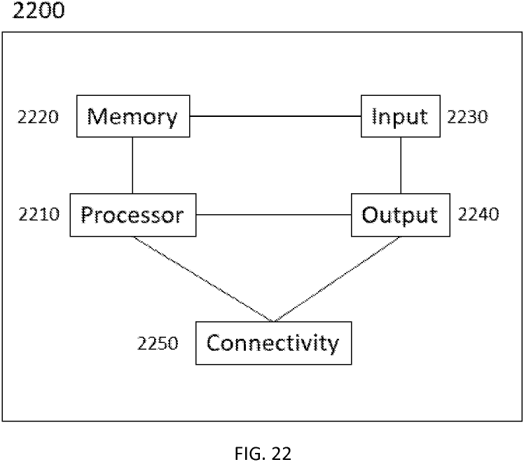

FIG. 22 illustrates an apparatus 2200, which may be an apparatus such as, or comprised in, a terminal device, according to an exemplary embodiment. The apparatus 2200 comprises a processor 2210. The processor 2210 interprets computer program instructions and processes data. The processor 2210 may comprise one or more programmable processors. The processor 2210 may comprise programmable hardware with embedded firmware and may, alternatively or additionally, comprise one or more application specific integrated circuits, ASICs.

The processor 2210 is coupled to a memory 2220. The processor is configured to read and write data to and from the memory 2220. The memory 2220 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example RAM, DRAM or SDRAM. Non-volatile memory may be for example ROM, PROM, EEPROM, flash memory, optical storage or magnetic storage. In general, memories may be referred to as non-transitory computer readable media. The memory 2220 stores computer readable instructions that are executed by the processor 2210. For example, non-volatile memory stores the computer readable instructions and the processor 2210 executes the instructions using volatile memory for temporary storage of data and/or instructions.

The computer readable instructions may have been pre-stored to the memory 2220 or, alternatively or additionally, they may be received, by the apparatus, via electromagnetic carrier signal and/or may be copied from a physical entity such as a computer program product. Execution of the computer readable instructions causes the apparatus 2200 to perform functionality described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 2200 may further comprise, or be connected to, an input unit 2230. The input unit 2230 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 2230 may comprise an interface to which external devices may connect to.

The apparatus 2200 may also comprise an output unit 2240. The output unit may comprise or be connected to one or more displays capable of rendering visual content such as a light emitting diode, LED, display, a liquid crystal display, LCD and a liquid crystal on silicon, LCoS, display. The output unit 2240 may further comprise one or more audio outputs. The one or more audio outputs may be for example loudspeakers.

The apparatus 2200 further comprises a connectivity unit 2250. The connectivity unit 2250 enables wireless connectivity to one or more external devices. The connectivity unit 2250 comprises at least one transmitter and at least one receiver that may be integrated to the apparatus 2200 or that the apparatus 2200 may be connected to. The at least one transmitter comprises at least one transmission antenna, and the at least one receiver comprises at least one receiving antenna. The connectivity unit 2250 may comprise an integrated circuit or a set of integrated circuits that provide the wireless communication capability for the apparatus 2200. Alternatively, the wireless connectivity may be a hardwired application specific integrated circuit, ASIC. The connectivity unit 2250 may comprise one or more components such as a power amplifier, digital front end, DFE, analog-to-digital converter, ADC, digital-to-analog converter, DAC, polarization controller, frequency converter, (de)modulator, and/or encoder/decoder circuitries, controlled by the corresponding controlling units.

It is to be noted that the apparatus 2200 may further comprise various components not illustrated in FIG. 22. The various components may be hardware components and/or software components.

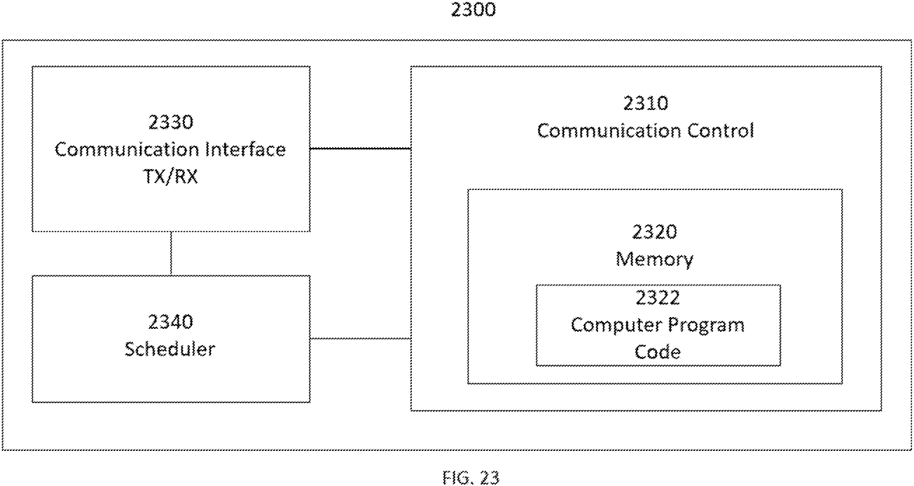

The apparatus 2300 of FIG. 23 illustrates an exemplary embodiment of an apparatus that may be a base station or comprised in a base station, such as a gNB. The apparatus may comprise, for example, a circuitry or a chipset applicable to a base station for realizing the described exemplary embodiments. The apparatus 2300 may be an electronic device comprising one or more electronic circuitries. The apparatus 2300 may comprise a communication control circuitry 2310 such as at least one processor, and at least one memory 2320 including computer program code (software) 2322 wherein the at least one memory and the computer program code (software) 2322 are configured, with the at least one processor, to cause the apparatus 2300 to carry out some of the exemplary embodiments described above.

The memory 2320 may be implemented using any suitable data storage technology, such as semiconductor-based memory devices, flash memory, magnetic memory devices and systems, optical memory devices and systems, fixed memory and removable memory. The memory may comprise a configuration database for storing configuration data. For example, the configuration database may store a current neighbour cell list, and, in some exemplary embodiments, structures of the frames used in the detected neighbour cells.

The apparatus 2300 may further comprise a communication interface 2330 comprising hardware and/or software for realizing communication connectivity according to one or more communication protocols. The communication interface 2330 may provide the apparatus with radio communication capabilities to communicate in the cellular communication system. The communication interface may, for example, provide a radio interface to terminal devices. The apparatus 2300 may further comprise another interface towards a core network such as the network coordinator apparatus and/or to the access nodes of the cellular communication system. The apparatus 2300 may further comprise a scheduler 2340 that is configured to allocate resources.

As used in this application, the term “circuitry” may refer to one or more or all of the following:
a. hardware-only circuit implementations (such as implementations in only analog and/or digital circuitry) and
b. combinations of hardware circuits and software, such as (as applicable):
   i. a combination of analog and/or digital hardware circuit(s) with software/firmware and
   ii. any portions of hardware processor(s) with software (including digital signal processor(s)), software, and memory(ies) that work together to cause an apparatus, such as a mobile phone, to perform various functions) and
c. hardware circuit(s) and or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1. An apparatus comprising at least one processor, and at least one memory storing instructions that, when executed by the at least one processor, to cause the apparatus to:
increase an antenna isolation between a first antenna panel and a second antenna panel by adjusting a radiation pattern associated with the first antenna panel and/or with the second antenna panel; and
receive a first signal via the first antenna panel and transmit a second signal via the second antenna panel substantially simultaneously.

2. An apparatus according to claim 1, further comprising maintaining the antenna isolation at least at a pre-defined level by adjusting the radiation pattern.

3. An apparatus according to claim 1, wherein the first antenna panel and the second antenna panel are separated by a distance of at least two wavelengths, wherein the at least two wavelengths are inversely proportional to a carrier frequency used by the apparatus.

4. An apparatus according to claim 1, wherein the radiation pattern is adjusted, while maintaining a direction of at least one beam.

5. An apparatus according to claim 1, further comprising adjusting an angular direction of the at least one beam, while maintaining the antenna isolation at a pre-defined level.

6. An apparatus according to claim 1, wherein the first antenna panel and the second antenna panel comprise a plurality of antenna elements, and the radiation pattern is adjusted by adjusting a power level on one or more antenna elements comprised in the plurality of antenna elements, and/or by adjusting an amplitude and/or phase associated with the one or more antenna elements.

7. An apparatus according to claim 1, wherein the radiation pattern is adjusted based on a pre-defined antenna beamforming codebook comprising a plurality of entries indicating antenna radiation pattern configurations for a time-division duplexing mode and for a full-duplex mode.

8. An apparatus according to claim 1, further comprising switching the apparatus from the time-division duplexing mode to the full-duplex mode.

9. An apparatus according to claim 8,
wherein the first antenna panel and the second antenna panel are enabled, while the apparatus is in the full-duplex mode;
wherein the first antenna panel is enabled and the second antenna panel is disabled, while the apparatus is in the time-division duplexing mode; and
wherein the first antenna panel is capable of transmitting and receiving, while the apparatus is in the time-division duplexing mode, wherein the transmitting and receiving is performed at substantially different time instants.

10. An apparatus according to claim 1, further comprising:
establishing, via the first antenna panel, a connection to a base station, while in the time-division duplexing mode;
measuring, via the second antenna panel, a quality indicator associated with the connection to the base station, while in the time-division duplexing mode;
determining the antenna isolation between the first antenna panel and the second antenna panel, while in the time-division duplexing mode;
transmitting an indication to the base station, if the quality indicator and the antenna isolation exceed a pre-defined threshold value, while in the time-division duplexing mode; and
receiving from the base station instructions to switch from the time-division duplexing mode to the full-duplex mode.

11. An apparatus according to claim 1, further comprising performing self-interference cancellation with analog filtering and digital cancellation.

12. An apparatus according to claim 1, wherein the apparatus is comprised in a terminal device.

13-15. (canceled)

16. A method comprising:
increasing an antenna isolation between a first antenna panel and a second antenna panel by adjusting a radiation pattern associated with the first antenna panel and/or with the second antenna panel; and
receiving a first signal via the first antenna panel and transmitting a second signal via the second antenna panel substantially simultaneously.

17. A non-transitory computer readable medium comprising program instructions that, when executed by an apparatus, cause the apparatus to perform at least the following:
increase an antenna isolation between a first antenna panel and a second antenna panel by adjusting a radiation pattern associated with the first antenna panel and/or with the second antenna panel; and
receive a first signal via the first antenna panel and transmit a second signal via the second antenna panel substantially simultaneously.

18. The method according to claim 16, further comprising maintaining the antenna isolation at least at a pre-defined level by adjusting the radiation pattern.

19. The method according to claim 16, wherein the first antenna panel and the second antenna panel are separated by a distance of at least two wavelengths, wherein the at least two wavelengths are inversely proportional to a carrier frequency.

20. The method according to claim 16, wherein the radiation pattern is adjusted, while maintaining a direction of at least one beam.

21. The method according to claim 16, further comprising adjusting an angular direction of the at least one beam, while maintaining the antenna isolation at a pre-defined level.

22. The method according to claim 16, wherein the first antenna panel and the second antenna panel comprise a plurality of antenna elements, and the radiation pattern is adjusted by adjusting a power level on one or more antenna elements comprised in the plurality of antenna elements, and/or by adjusting an amplitude and/or phase associated with the one or more antenna elements.

23. The method according to claim 16, wherein the radiation pattern is adjusted based on a pre-defined antenna beamforming codebook comprising a plurality of entries indicating antenna radiation pattern configurations for a time-division duplexing mode and for a full-duplex mode.
